(19) United States
(12) Patent Application Publication
(10) Pub. No.: US 2020/0302890 A1
(43) Pub. Date: Sep. 24, 2020

(54) Power Supply Apparatus and Display System

(71) Applicants: HKC Corporation Limited, (CN); Chongqing HKC Optoelectronics Technology Co., Ltd., (CN)

(72) Inventor: Mingliang Wang, (US)

(21) Appl. No.: 16/621,182

(22) PCT Filed: Dec. 14, 2017
(86) PCT No.: PCT/CN2017/116275

§ 371 Date: Dec. 10, 2019

(30) Foreign Application Priority Data
Apr. 25, 2017 (CN) 2017106125979

(51) Int. Cl. G09G 3/36; G06F 1/28

(52) U.S. Cl. CPC G09G 3/3696; G09G 2330/025; G06F 1/28

(57) ABSTRACT

The present disclosure illustrates a power supply device and a display system using the same. The power supply device includes: a power supply module comprising a positive output terminal and a negative output terminal, and configured to provide an output voltage; a regulator module comprising a terminal electrically connected to the positive output terminal of the power supply module, and other terminal electrically connected to the negative output terminal of the power supply module, wherein the negative output terminal of the power supply module is electrically connected to ground, and the regulator module is configured to control the power supply module to stably output the output voltage; and a frequency regulation module comprising an input terminal electrically connected to an external controller, an output terminal electrically connected to the regulator module, and regulate a working frequency of the regulator module by a control signal received from the external controller.

### CROSS-REFERENCE TO RELATED APPLICATION

This application claims the benefit of China Patent Application No. 201710612597.9, filed on Jul. 25, 2017, in the State Intellectual Property Office of the People's Republic of China, the disclosure of which is incorporated herein in its entirety by reference.

### BACKGROUND

### 1. Field of the Invention

The present disclosure relates to an electronic technology field, more particularly to a power supply device and a display system using the same.

### 2. Description of the Related Art

In recent years, the development trend of LCD television is towards large size and high-resolution, so the power consumption of the LCD television is also increasing. Furthermore, with increasing of the power consumption of the LCD television, the electromagnetic interference (EMI) produced by the components of the LCD television becomes worse; particularly, the electromagnetic radiation from the power source is the most serious. Because the LCD television product must pass national verification standards before delivery, how to reduce the EMI effect caused by the power source is an important issue.

The existing solution is to add an EMI suppression component at the output side of the power source, or use a RC buffer circuit which is a circuit including a resistor and a capacitance electrically connected in series. However, the EMI suppression component only can reduce a portion of the conduction interference but is unable to reduce the radiation interference. The RC buffer circuit is effective for small power circuit, but generally does not work for reducing EMI effect of large power circuit.

### SUMMARY

The present disclosure provides a power supply device and a display system using the same. The power supply device has a simple structure and can reduce the electromagnetic radiation on a basis of the input power source stably supplying power, thereby reducing the electromagnetic radiation interference caused by the power source.

According to an embodiment, the present disclosure provides a power supply device comprising: a power supply module comprising a positive output terminal and a negative output terminal, and configured to provide an output voltage; a regulator module comprising a terminal electrically connected to the positive output terminal of the power supply module, and other terminal electrically connected to the negative output terminal of the power supply module, wherein the negative output terminal of the power supply module is electrically connected to ground, and the regulator module is configured to control the power supply module to stably output the output voltage; and a frequency regulation module comprising an input terminal electrically connected to an external controller, an output terminal electrically connected to the regulator module, and configured to regulate a working frequency of the regulator module by a control signal received from the external controller.

The power supply module comprise an input power source and an inductor, and an anode of the input power source is electrically connected to a terminal of the inductor, and other terminal of the inductor is electrically connected to the terminal of the regulator module, and a cathode of the input power source is electrically connected to the other terminal of the regulator module.

The power supply module comprises a diode comprising an anode electrically connected to the other terminal of the inductor, and a cathode served as the positive output terminal of the power supply module.

The power supply module comprises a capacitor comprising a terminal electrically connected to the cathode of the diode, and other terminal electrically connected to the cathode of the input power source.

The regulator module comprises: an oscillator comprising an input terminal electrically connected to the output terminal of the frequency regulation module; a first comparator comprising a non-inverting input terminal electrically connected to a reference voltage; a second comparators comprising an inverting input terminal electrically connected to the oscillator comprising, and a non-inverting input terminal electrically connected to an output terminal of the first comparator; a switch unit comprising a gate electrically connected to the output terminal of the second comparator, a source electrically connected to ground, and a drain of electrically connected to the other terminal of the inductor; a first resistor comprising a terminal electrically connected to the positive output terminal of the power supply module, and other terminal electrically connected to the inverting input terminal of the first comparator; and a second resistor comprising a terminal electrically connected to the other terminal of the first resistor, and other terminal electrically connected to ground.

The frequency regulation module comprises: a decoding unit configured to receive and decode the control signal from the external controller; a digital-to-analog conversion unit configured to perform digital-to-analog conversion on the decoded control signal, and transmit to the oscillator to regulate the frequency of the output voltage of the oscillator.

The decoding unit is a synchronous serial decoding unit communicating with the external controller through the synchronous serial bus.

The regulator module comprises a temperature detection unit electrically connected to the synchronous serial decoding unit through the digital-to-analog conversion unit, and after the digital-to-analog conversion is performed on a temperature detection signal, and the converted temperature detection signal is transmitted to the external controller through the synchronous serial bus.

According to an embodiment, the present disclosure provides a power supply device comprising: a power supply module comprising a positive output terminal and a negative output terminal, and configured to provide an output voltage; a regulator module comprising a terminal electrically connected to the positive output terminal of the power supply module, and other terminal electrically connected to the negative output terminal of the power supply module, wherein the negative output terminal of the power supply module is electrically connected to ground, and the regulator module controls the power supply module to stably output the output voltage; and a frequency regulation module comprising an input terminal electrically connected to the external controller, and other terminal electrically connected to the regulator module, and configured to regulate a working frequency of the regulator module by a control signal received from the external controller; wherein the power supply module comprises: an input power source comprising a cathode electrically connected to the terminal of the regulator module; an inductor comprising an terminal electrically connected to an anode of the input power source, and other terminal electrically connected to the terminal of the regulator module; and a diode comprising an anode electrically connected to other terminal of the inductor, and a cathode served as the positive output terminal of the power supply module; wherein the regulator module comprises: an oscillator comprising an input terminal electrically connected to the output terminal of the frequency regulation module; a first comparator comprising a non-inverting input terminal electrically connected to a reference voltage; a second comparators comprising an inverting input terminal electrically connected to the output terminal the oscillator, and a non-inverting input terminal electrically connected to an output terminal of the first comparator; a switch unit, wherein an output terminal of the second comparators is electrically connected to a gate of the switch unit, a source of the switch unit is electrically connected to ground, and a drain of the switch unit is electrically connected to the other terminal of the inductor; a first resistor comprising a terminal electrically connected to the positive an output terminal of the power supply module, and other terminal electrically connected to the inverting input terminal of the first comparator; and a second resistor comprising a terminal electrically connected to the terminal of the first resistor, and other terminal electrically connected to ground.

According to an embodiment, the present disclosure provides a display system, comprising: a display panel; and a power supply device configured to supply power to the display panel, and the power supply device comprising: a power supply module comprising a positive output terminal and a negative output terminal, and configured to provide the output voltage; a regulator module comprising a terminal electrically connected to the positive output terminal of the power supply module, and other terminal electrically connected to the negative output terminal of the power supply module, wherein the negative output terminal of the power supply module is electrically connected to ground, the regulator module controls the power supply module to stably output the output voltage; and a frequency regulation module comprising an input terminal electrically connected to the external controller, and the output terminal electrically connected to the regulator module, and configured to regulate a working frequency of the regulator module by a control signal received from the external controller.

The power supply module comprises an input power source and an inductor, the input power source comprises an anode electrically connected to the terminal of the inductor, and other terminal of the inductor is electrically connected to the terminal of the regulator module, and a cathode of the input power source is electrically connected to the terminal of the regulator module.

The power supply module comprises a diode comprising an anode electrically connected to other terminal of the inductor, and a cathode served as the positive output terminal of the power supply module.

The power supply module comprises a capacitor comprising a terminal electrically connected to the cathode of the diode, and other terminal electrically connected to the cathode of the input power source.

The regulator module comprises: an oscillator comprising an input terminal electrically connected to the output terminal of the frequency regulation module; a first comparator comprising a non-inverting input terminal electrically connected to a reference voltage; a second comparators comprising an inverting input terminal electrically connected to the output terminal of the oscillator, and a non-inverting input terminal electrically connected to an output terminal of the first comparator; a switch unit, wherein an output terminal of the second comparators is electrically connected to a gate of the switch unit, a source of the switch unit is electrically connected to ground, a drain of the switch unit is electrically connected to the other terminal of the inductor; a first resistor comprising a terminal electrically connected to the positive output terminal of the power supply module, and other terminal electrically connected to the inverting input terminal of the first comparator; and a second resistor comprising a terminal electrically connected to the other terminal of the first resistor, and other terminal electrically connected to ground.

The frequency regulation module comprises: a decoding unit configured to receive and decode the control signal from the external controller; a digital-to-analog conversion unit configured to perform digital-to-analog conversion on the decoded the control signal, and transmit to the oscillator to regulate the frequency of the output voltage of the oscillator.

The decoding unit is a synchronous serial the decoding unit communicating with the external controller through a synchronous serial bus.

The regulator module comprises a temperature detection unit electrically connected to the synchronous serial the decoding unit through the digital-to-analog conversion unit, after the digital-to-analog conversion is performed on a temperature detection signal and the converted signal is transmitted to the external controller through the synchronous serial bus.

The power supply device of the present disclosure has the simple structure and can reduce the electromagnetic radiation in a basis of the input power source stably supplying power, thereby reducing the electromagnetic radiation interference. The power supply device of the present disclosure uses the frequency regulation module to regulate the frequency of the regulator module, so as to distribute the frequency in a certain range, and distribute the radiation energy of the power source on different frequency bands, and prevent the radiation energy from being excessively centralized on certain frequency, thereby reducing the electromagnetic radiation interference for other components. Furthermore, the temperature detection unit is able to detect an internal temperature of the regulator module, thereby protecting entire power supply device.

### BRIEF DESCRIPTION OF THE DRAWINGS

The structure, operating principle and effects of the present disclosure will be described in detail by way of various embodiments which are illustrated in the accompanying drawings.

FIG. 1 is a block diagram of a power supply device of an embodiment of the present disclosure;

FIG. 2 is a circuit diagram of a power supply device of an embodiment of the present disclosure;

FIG. 3 is a radiation value diagram before the frequency regulation module is activated;

FIG. 4 is a frequency diagram of the oscillator after the frequency regulation module is activated;

FIG. 5 is a radiation value diagram after the frequency regulation module is activated;

FIG. 6 is a block diagram of a display system of an embodiment of the present disclosure.

### DETAILED DESCRIPTION OF THE PREFERRED EMBODIMENTS

The following embodiments of the present disclosure are herein described in detail with reference to the accompanying drawings. These drawings show specific examples of the embodiments of the present disclosure. It is to be understood that these embodiments are exemplary implementations and are not to be construed as limiting the scope of the present disclosure in any way. Further modifications to the disclosed embodiments, as well as other embodiments, are also included within the scope of the appended claims. These embodiments are provided so that this disclosure is thorough and complete, and fully conveys the inventive concept to those skilled in the art. Regarding the drawings, the relative proportions and ratios of elements in the drawings may be exaggerated or diminished in size for the sake of clarity and convenience. Such arbitrary proportions are only illustrative and not limiting in any way. The same reference numbers are used in the drawings and description to refer to the same or like parts.

It is to be understood that, although the terms ‘first’, ‘second’, ‘third’, and so on, may be used herein to describe various elements, these elements should not be limited by these terms. These terms are used only for the purpose of distinguishing one component from another component. Thus, a first element discussed herein could be termed a second element without altering the description of the present disclosure. As used herein, the term “or” includes any and all combinations of one or more of the associated listed items.

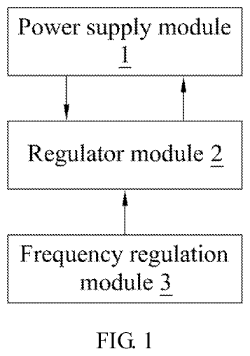

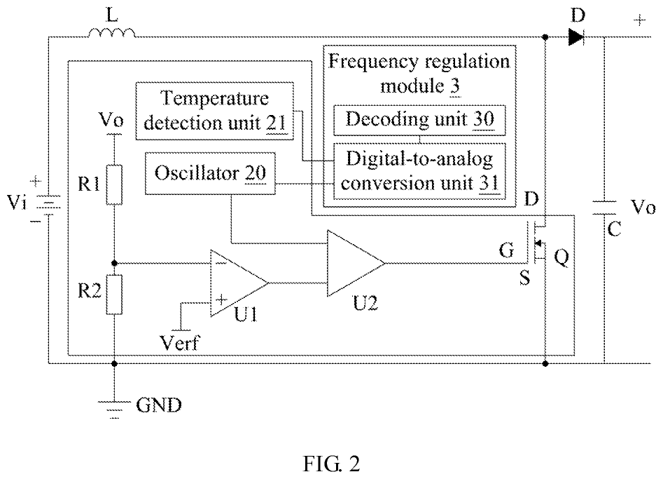

Please refer to FIGS. 1 and 2. In this embodiment, the power supply device includes a power supply module 1 configured to provide an output voltage Vo; and a regulator module 2 comprising a terminal electrically connected to the positive output terminal of the power supply module 1, and other terminal electrically connected to the negative output terminal of the power supply module 1. The negative output terminal of the power supply module 1 is electrically connected to ground, and the regulator module 2 can control the power supply module 1 to stably output the output voltage Vo. The power supply device includes a frequency regulation module 3 comprising an input terminal electrically connected to the external controller, and an output terminal electrically connected to the regulator module 2. The frequency regulation module 3 can regulate a working frequency of the regulator module 2 by a control signal received from an external controller.

While the power supply module 1 outputs the voltage, the regulator module 2 usually generates a drive signal with fixed frequency to ensure the stability of the output voltage, and it may cause that the radiation produced by the regulator module 2 is centralized on the fixed frequency, and the magnitude of radiation may exceed a standard. In order to solve the problem, the external controller can control the frequency regulation module 3 to regulate the generated drive signal, so as to distribute the frequency of the drive signal on a basis of stable power supply of the power supply module 1, thereby reducing the magnitude of the radiation.

Optionally, the power supply module 1 comprises an input power source Vi and an inductor L. The input power source Vi includes an anode electrically connected to the terminal of the inductor L, and the inductor L includes other terminal electrically connected to a terminal of the regulator module 2, and the input power source Vi includes a cathode electrically connected to the terminal of the regulator module 2. The inductor L is able to continuously charge and discharge under control of the regulator module 2, thereby achieving the purpose of stably regulating the output voltage Vo.

Optionally, the power supply module 1 can include a diode D including an anode electrically connected to the other terminal of the inductor L, and a cathode served as the positive output terminal of the power supply module. The anode of the diode D is also electrically connected to the terminal of the regulator module 2. The diode D is used to ensure the stability of the output voltage of the power source, and effectively protect the power supply module and improve the safety of the power supply module.

The power supply module 1 includes a capacitor C. A terminal of the capacitor C is electrically connected to the cathode of the diode D, and other terminal of the capacitor C is electrically connected to the cathode of the input power source. The capacitor C can also be used to ensure the stability of the output voltage of the power supply module 1.

The regulator module 2 can further include an oscillator 20, a first comparator U1, a second comparator U2, a switch unit Q, a first resistor R1 and a second resistor R2. The oscillator 20 includes an input terminal electrically connected to the output terminal of the frequency regulation module 3, and an output terminal electrically connected to an inverting input terminal of the second comparators U2. The first resistor R1 includes a terminal electrically connected to the positive output terminal of the power supply module 1, and other terminal electrically connected to a terminal of the second resistor R2, and the other terminal of the second resistor R2 is electrically connected to ground. The terminal of first resistor R1 is also electrically connected to the inverting input terminal of the first comparator U1. A non-inverting input terminal of the first comparator U1 is electrically connected to a reference voltage Vref, and an output terminal of the first comparator U1 is electrically connected to the non-inverting input terminal of the second comparators U2, and the output terminal of the second comparators U2 is electrically connected to a gate of the switch unit Q. A source of the switch unit Q is electrically connected to ground, and a drain of the switch unit Q is electrically connected to the other terminal of the inductor L.

The following describes a particular work principle of the regulator module 2 electrically connected to the frequency regulation module 3. The output voltage Vo is divided by the first resistor R1 and the second resistor R2 to generate a feedback voltage. After the first comparator U1 compares the feedback voltage with the reference voltage Vref, the first comparator U1 outputs a comparison result through an output terminal thereof, to generate a first output signal. The oscillator generates a triangular waveform signal with a cycle Ts, and the second comparator U2 compares the triangular waveform signal with the first output signal, to generate a second output signal. The switch unit Q is controlled to turn on or off according to the second output signal, so as to charge or discharge the inductor L.

For example, when the output voltage Vo is overly large, the feedback voltage is also increased; and when the feedback voltage is higher than the reference voltage Vref, the first comparator U1 outputs a first output signal with a low level through the output terminal thereof, and the second comparator U2 then compares the first output signal with the triangular waveform from the oscillator 20. As a result, a ratio of the high level portion in the second output signal from the second comparator U2 becomes smaller, and the time when the switch unit Q is turned on also becomes smaller, and the time when the inductor L is charged becomes smaller, so that the output voltage Vo becomes smaller correspondingly. Particularly, when the first output signal is higher than the signal outputted from the oscillator 20, the second output signal outputted from the second comparator is at high level, and the switch unit Q is turned on by the high-level signal, so that the inductor L is charged. In contrast, when the first output signal is lower than the signal outputted from the oscillator 20, the second output signal outputted from the second comparator is at low level, and the switch unit Q is turned off by the low-level signal, so that the inductor L discharges. Because the discharge time of the inductor L is longer than the charge time of the inductor L, the output voltage Vo is decreased slowly.

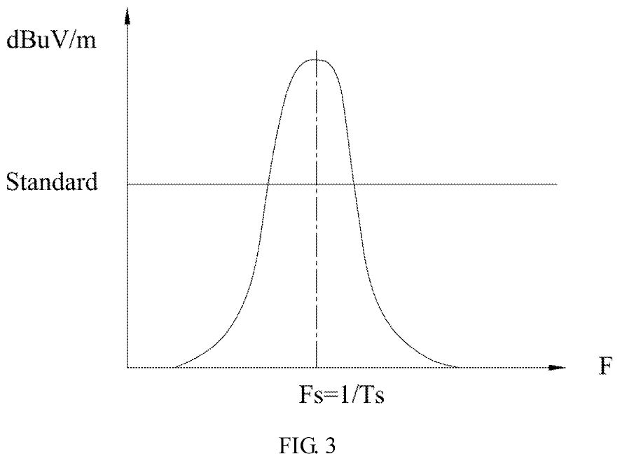

Please refer to FIGS. 3, 4 and 5. The triangular waveform signal outputted from the oscillator 20 is a drive signal with a fixed cycle Ts, so the radiation interference is centralized in the frequency band Fs (1/Ts=Fs), and the magnitude dBuV/m of the radiation exceeds a standard. Upon receipt of the control signal of the external controller, the frequency regulation module 3 can distribute the frequency of the drive signal outputted from the oscillator 20 upon actual condition, so as to greatly reduce the radiation and reduce the effect caused by the centralization of the radiation energy for other components, and further prevent from injuring the user's body.

Optionally, the frequency regulation module 3 can include a decoding unit 30 configured to receive and decode the control signal from the external controller; and a digital-to-analog conversion unit 31 configured to perform digital-to-analog conversion on the decoded the control signal, and transmit the converted signal to the oscillator to regulate the frequency of the output voltage of the oscillator. Furthermore, the decoding unit 30 can be a synchronous serial decoding unit communicating with the external controller through the synchronous serial bus. The synchronous serial bus can be an I²C bus.

The following describes the particular work principle. The synchronous serial decoding unit is electrically connected to the external controller through the synchronous serial bus, and determines, through the synchronous serial bus, whether entire frequency regulation module is activated, and sets parameters, such as frequency regulation time and regulation magnitude, after the frequency regulation module is activated. More particularly, the frequency regulation module can perform the regulation upon the actual condition of the electromagnetic radiation. As a result, the solution of the present disclosure can be implemented easily.

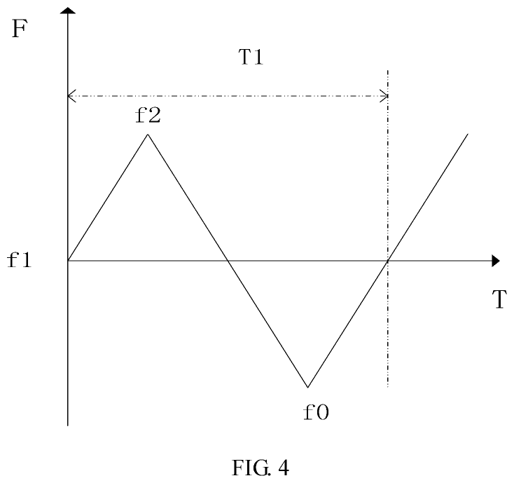

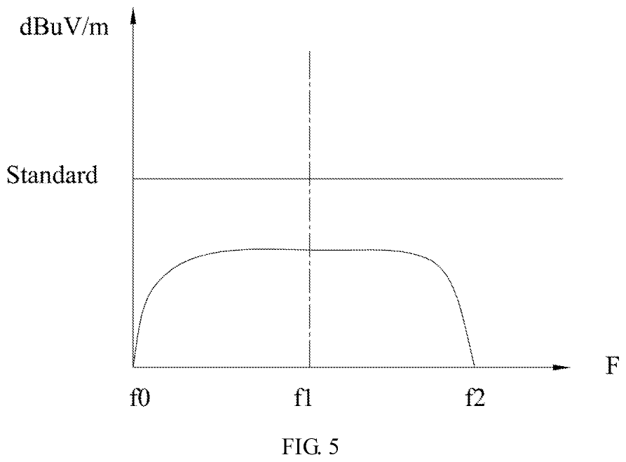

The digital-to-analog conversion unit 31 can convert the digital signal into an analog voltage signal, and the different frequency setting corresponds to different digital signal, so that the digital-to-analog conversion unit can convert the digital signal to output different analog output voltage, and the analog output voltage is outputted to the voltage-controlled unit of the oscillator. The voltage-controlled unit is configured to control the oscillation with different frequency according to different voltage, so that the external controller can output the synchronous serial setting signal to control the generation of the frequency. As shown in FIG. 4, when the reference frequency of oscillator the is f1 and the frequency regulation is set to change from f0 to f2 within T1 period, the frequency of the oscillator is changed from frequency f0 to frequency f1, and then from frequency f1 to frequency f0(f0←→f1←→f2) repeatedly, thereby significantly reducing the radiation energy, as shown in FIG. 5.

After the frequency of the drive signal outputted from the oscillator 20 is distributed, the radiation energy of the power supply device can be distributed on different frequency bands, so as to prevent the radiation energy from being excessively centralized on certain frequency, thereby reducing the electromagnetic radiation effect.

Furthermore, optionally, the regulator module 2 can include a temperature detection unit 21 electrically connected to the synchronous serial decoding unit through the digital-to-analog conversion unit 31, and after the digital-to-analog conversion is performed on a temperature detection signal, the converted signal is transmitted to the external controller through the synchronous serial bus. The temperature detection unit 21 can convert the internal temperature of the regulator module 2 into the digital format, and transmit the digital data to the external controller through the synchronous serial bus, so as to facilitate the user to understand and regulate the internal temperature of the regulator module 2.

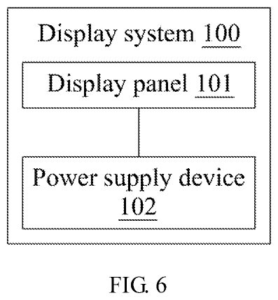

Please refer to FIG. 6. The present disclosure provides a display system 100 including a display panel 101 and the power supply device 102 of above embodiment. The power supply device 102 is configured to supply power to the display panel 101, and comprises the power supply module 1, the regulator module 2 and the frequency regulation module 3.

For example, the display panel 101 can be LCD panel, OLED display panel, Q LED display panel, curved display panel or other type display panel, but the present disclosure is not limited thereto.

The work principle of the power supply device 102 is similar to that described in above content, so detailed description is not repeated.

The present disclosure disclosed herein has been described by means of specific embodiments. However, numerous modifications, variations and enhancements can be made thereto by those skilled in the art without departing from the spirit and scope of the disclosure set forth in the claims.

What is claimed is:

1. A power supply device, comprise:
a power supply module comprising a positive output terminal and a negative output terminal, and configured to provide an output voltage;
a regulator module comprising a terminal electrically connected to the positive output terminal of the power supply module, and other terminal electrically connected to the negative output terminal of the power supply module, wherein the negative output terminal of the power supply module is electrically connected to ground, and the regulator module is configured to control the power supply module to stably output the output voltage; and
a frequency regulation module comprising an input terminal electrically connected to an external controller, an output terminal electrically connected to the regulator module, and configured to regulate a working frequency of the regulator module by a control signal received from the external controller.

2. The power supply device according to claim 1, wherein the power supply module comprise an input power source and an inductor, and an anode of the input power source is electrically connected to a terminal of the inductor, and other terminal of the inductor is electrically connected to the terminal of the regulator module, and a cathode of the input power source is electrically connected to the other terminal of the regulator module.

3. The power supply device according to claim 2, wherein the power supply module comprises a diode comprising an anode electrically connected to the other terminal of the inductor, and a cathode served as the positive output terminal of the power supply module.

4. The power supply device according to claim 3, wherein the power supply module comprises a capacitor comprising a terminal electrically connected to the cathode of the diode, and other terminal electrically connected to the cathode of the input power source.

5. The power supply device according to claim 2, wherein the regulator module comprises:
an oscillator comprising an input terminal electrically connected to the output terminal of the frequency regulation module;
a first comparator comprising a non-inverting input terminal electrically connected to a reference voltage;
a second comparator comprising an inverting input terminal electrically connected to the oscillator comprising, and a non-inverting input terminal electrically connected to an output terminal of the first comparator;
a switch unit comprising a gate electrically connected to the output terminal of the second comparator, a source electrically connected to ground, and a drain of electrically connected to the other terminal of the inductor;
a first resistor comprising a terminal electrically connected to the positive output terminal of the power supply module, and other terminal electrically connected to the inverting input terminal of the first comparator; and
a second resistor comprising a terminal electrically connected to the other terminal of the first resistor, and other terminal electrically connected to ground.

6. The power supply device according to claim 5, wherein the frequency regulation module comprises:
a decoding unit configured to receive and decode the control signal from the external controller;
a digital-to-analog conversion unit configured to perform digital-to-analog conversion on the decoded control signal, and transmit to the oscillator to regulate the frequency of the output voltage of the oscillator.

7. The power supply device according to claim 6, wherein the decoding unit is a synchronous serial decoding unit communicating with the external controller through the synchronous serial bus.

8. The power supply device according to claim 7, wherein the regulator module comprises a temperature detection unit electrically connected to the synchronous serial decoding unit through the digital-to-analog conversion unit, and after the digital-to-analog conversion is performed on a temperature detection signal, and the converted temperature detection signal is transmitted to the external controller through the synchronous serial bus.

9. A power supply device, comprising:
a power supply module comprising a positive output terminal and a negative output terminal, and configured to provide an output voltage;
a regulator module comprising a terminal electrically connected to the positive output terminal of the power supply module, and other terminal electrically connected to the negative output terminal of the power supply module, wherein the negative output terminal of the power supply module is electrically connected to ground, and the regulator module controls the power supply module to stably output the output voltage; and
a frequency regulation module comprising an input terminal electrically connected to the external controller, and other terminal electrically connected to the regulator module, and configured to regulate a working frequency of the regulator module by a control signal received from the external controller;
wherein the power supply module comprises:
an input power source comprising a cathode electrically connected to the terminal of the regulator module;
an inductor comprising an terminal electrically connected to an anode of the input power source, and other terminal electrically connected to the terminal of the regulator module; and
a diode comprising an anode electrically connected to other terminal of the inductor, and a cathode served as the positive output terminal of the power supply module;
wherein the regulator module comprises:
an oscillator comprising an input terminal electrically connected to the output terminal of the frequency regulation module;
a first comparator comprising a non-inverting input terminal electrically connected to a reference voltage;
a second comparators comprising an inverting input terminal electrically connected to the output terminal the oscillator, and a non-inverting input terminal electrically connected to an output terminal of the first comparator;
a switch unit, wherein an output terminal of the second comparators is electrically connected to a gate of the switch unit, a source of the switch unit is electrically connected to ground, and a drain of the switch unit is electrically connected to the other terminal of the inductor;
a first resistor comprising a terminal electrically connected to the positive an output terminal of the power supply module, and other terminal electrically connected to the inverting input terminal of the first comparator; and
a second resistor comprising a terminal electrically connected to the terminal of the first resistor, and other terminal electrically connected to ground.

10. A display system, comprising:
a display panel; and
a power supply device configured to supply power to the display panel, and the power supply device comprising:
a power supply module comprising a positive output terminal and a negative output terminal, and configured to provide the output voltage;
a regulator module comprising a terminal electrically connected to the positive output terminal of the power supply module, and other terminal electrically connected to the negative output terminal of the power supply module, wherein the negative output terminal of the power supply module is electrically connected to ground, the regulator module controls the power supply module to stably output the output voltage; and
a frequency regulation module comprising an input terminal electrically connected to the external controller, and the output terminal electrically connected to the regulator module, and configured to regulate a working frequency of the regulator module by a control signal received from the external controller.

11. The display system according to claim 10, wherein the power supply module comprises an input power source and an inductor, the input power source comprises an anode electrically connected to the terminal of the inductor, and other terminal of the inductor is electrically connected to the terminal of the regulator module, and a cathode of the input power source is electrically connected to the terminal of the regulator module.

12. The display system according to claim 11, wherein the power supply module comprises a diode comprising an anode electrically connected to other terminal of the inductor, and a cathode served as the positive output terminal of the power supply module.

13. The display system according to claim 12, wherein the power supply module comprise a capacitor comprising a terminal electrically connected to the cathode of the diode, and other terminal electrically connected to the cathode of the input power source.

14. The display system according to claim 11, wherein the regulator module comprises:
an oscillator comprising an input terminal electrically connected to the output terminal of the frequency regulation module;
a first comparator comprising a non-inverting input terminal electrically connected to a reference voltage;
a second comparators comprising an inverting input terminal electrically connected to the output terminal of the oscillator, and a non-inverting input terminal electrically connected to an output terminal of the first comparator;
a switch unit, wherein an output terminal of the second comparators is electrically connected to a gate of the switch unit, a source of the switch unit is electrically connected to ground, and a drain of the switch unit is electrically connected to the other terminal of the inductor;
a first resistor comprising a terminal electrically connected to the positive output terminal of the power supply module, and other terminal electrically connected to the inverting input terminal of the first comparator; and
a second resistor comprising a terminal electrically connected to the other terminal of the first resistor, and other terminal electrically connected to ground.

15. The display system according to claim 14, wherein the frequency regulation module comprises:
a decoding unit configured to receive and decode the control signal from the external controller;
a digital-to-analog conversion unit configured to perform digital-to-analog conversion on the decoded the control signal, and transmit to the oscillator to regulate the frequency of the output voltage of the oscillator.

16. The display system according to claim 15, wherein the decoding unit is a synchronous serial the decoding unit communicating with the external controller through a synchronous serial bus.

17. The display system according to claim 16, wherein the regulator module comprises a temperature detection unit electrically connected to the synchronous serial the decoding unit through the digital-to-analog conversion unit, after the digital-to-analog conversion is performed on a temperature detection signal and the converted signal is transmitted to the external controller through the synchronous serial bus.
